(19) United States
(12) Patent Application Publication
(10) Pub. No.: US 2012/0125150 A1
(43) Pub. Date: May 24, 2012

(54) GEARBOX FOR A WIND TURBINE

(75) Inventor: Ralf Martin Dinter, Gelsenkirchen (DE)

(73) Assignee: Winergy AG, Voerde (DE)

(21) Appl. No.: 13/112,422

(22) Filed: May 20, 2011

(30) Foreign Application Priority Data
May 21, 2010 (EP) EP10005310

(51) Int. Cl. F03D 11/02; F16J 15/16

(52) U.S. Cl. 74/730.1

(57) ABSTRACT

A gearbox includes an input shaft connected to a rotor hub, an output shaft connected to a generator, and a first gear wheel rotation-locked to the input shaft and arranged inside a gearbox housing. A second gear wheel arranged inside the gearbox housing and meshing with the first gear wheel or coupled thereto via one or more additional gear wheels is rotation-locked to the output shaft. A flange radially surrounds the input shaft and/or the output shaft and has a circumferential groove on a side facing the input shaft and/or output shaft. An annular tubular sealing element made from an elastic material is fixed in the circumferential groove and can be expanded by an increase in the internal pressure. An intermediate space between the input shaft and/or output shaft and the circumferential groove is thus completely sealed by the sealing element when expanded.

### CROSS-REFERENCES TO RELATED APPLICATIONS

This application claims the priority of European Patent Application, Serial No. EP10005310, filed May 21, 2010, pursuant to 35 U.S.C. 119(a)-(d), the content of which is incorporated herein by reference in its entirety as if fully set forth herein.

### BACKGROUND OF THE INVENTION

The present invention relates to a gearbox for a wind turbine, and more particularly a gearbox which prevents lubricant from leaking from the gearbox during transportation.

The following discussion of related art is provided to assist the reader in understanding the advantages of the invention, and is not to be construed as an admission that this related art is prior art to this invention.

In previously known solutions, input and output shafts in gearboxes for wind turbines are sealed without contact by means of gap or labyrinth seals. When a gearbox is being transported, particularly when being transported at sea, this is problematic as these kinds of seals do not effectively seal the gearbox when subjected to the movements and accelerations caused by the transportation and lubricant can escape from the gearbox. In order to solve this problem, traditional solutions include static supplementary seals which are fitted for transportation and must be removed before the turbine is put into operation.

It would therefore be desirable and advantageous to address this problem and to obviate other prior art shortcomings by providing a gearbox with an improved sealing effect in order to prevent lubricant from escaping from the gearbox while the gearbox is being transported.

### SUMMARY OF THE INVENTION

According to one aspect of the present invention, a gearbox for a wind turbine includes a gearbox housing, an input shaft which can be connected to a rotor hub, an output shaft which can be connected to a generator, a first gear wheel connected with a rotation-lock to the input shaft and arranged inside the gearbox housing, and a second gear wheel connected with a rotation-lock to the output shaft and arranged in the gearbox housing. The second gear wheel meshes with the first gear wheel or is coupled to the first gear wheel via one or more additional gear wheels. At least one flange radially surrounds at least one of the input shaft and the output shaft and has a circumferential groove on a side facing the input shaft or the output shaft. An inflatable annular tubular sealing element made from an elastic material is secured in the circumferential groove, with the sealing element radially expanding upon inflation and completely sealing an intermediate space between the circumferential groove and at least one of the input shaft or the output shaft.

The intermediate space between the input shaft or output shaft and the circumferential groove is thus completely sealed by the sealing element when it is expanded.

According to an advantageous feature of the invention, the sealing element may surround the input shaft or the output shaft without making contact therewith when the pressure inside the sealing element is reduced. As a result, the sealing element can remain permanently in the gearbox. There is consequently no need for supplementary seals which were previously commonly used and need to be expensively disassembled again after the gearbox has been transported, which reduces assembly cost for transportation and startup.

According to another advantageous feature of the invention, the sealing element may be coupled to a transport safety device which controls or regulates an internal pressure inside the sealing element.

According to another advantageous feature of the invention, the gearbox may include a gearbox housing cover for closing the gearbox housing, wherein the at least one flange is part of the housing cover.

According to yet another advantageous feature of the invention, the intermediate space may extend radially between the circumferential groove and at least one of the input shaft and the output shaft. In another advantageous embodiment of the invention, the circumferential groove may be disposed on a face side of the flange, with the input shaft or the output shaft spanning a flange section, and the intermediate space may extend axially between the flange section and the circumferential groove.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a diagrammatic view of a gearbox for a wind turbine according to the present invention;

FIG. 2 shows a perspective view of a housing cover with a sealing element having reduced internal pressure,

FIG. 3 shows a perspective view of a housing cover with a sealing element in an expanded state.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

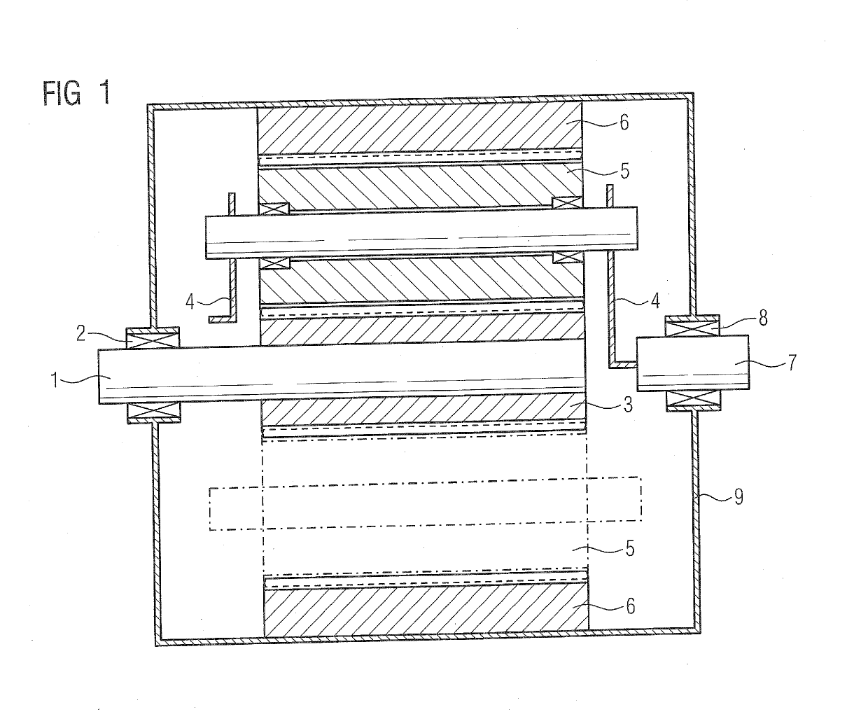

Turning now to the drawing, and in particular to FIG. 1, there is shown a gearbox for a wind turbine with a sun gear 3 connected to an input shaft 1, a hollow gear 6 and a planet gear carrier 4 in which a plurality of planet gears 5 are mounted and which is connected to an output shaft 7. The input shaft 1 can be connected to a rotor hub, while the output shaft 7 can be connected to a generator of the wind turbine. The hollow gear 6 can be integrated into a one- or multi-part gearbox housing 9 which also has bearing seats for bearings 2, 8 of the input shaft 1 and output shaft 7. The bearing seats can, for example, be integrated into the cover of the housing.

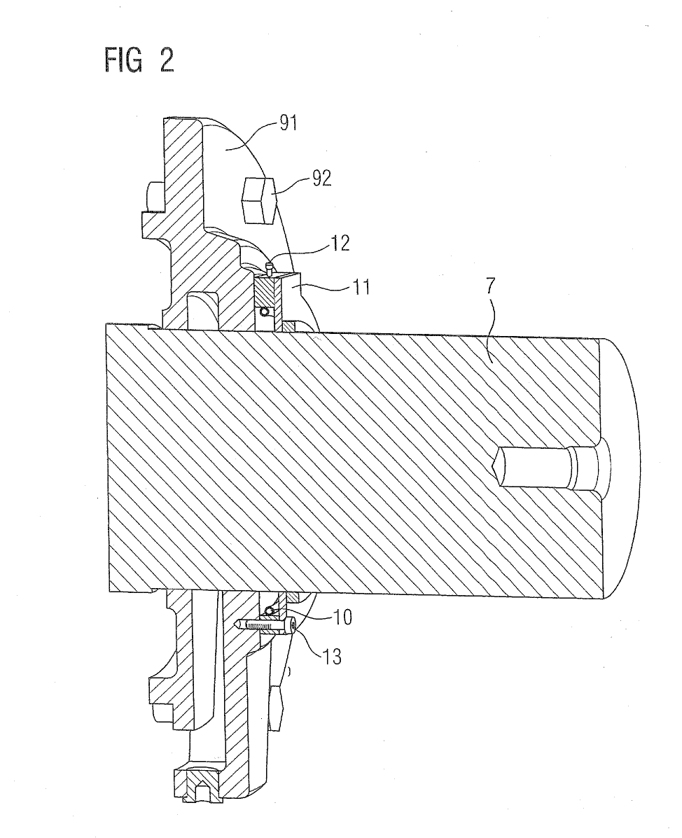

As shown in FIG. 2, the output shaft 7 is surrounded radially by a flange 11 which, for example, is fastened by means of a screw 13 to a housing cover 91 which closes the gearbox housing 9. In the present exemplary embodiment, the housing cover 91 is mounted on the gearbox housing 9 by means of a screw 92. The flange 11 could in principle also be integrally formed on the housing cover 91 or be connected materially or positively, as desired, to the housing cover 91.

On an inner shell side of the flange 11 facing the output shaft 7, a circumferential groove is provided in which is fixed an annular tubular sealing element 10 made from an elastic material. When there is a reduced internal pressure, the sealing element 10 surrounds the output shaft 7 without making contact.

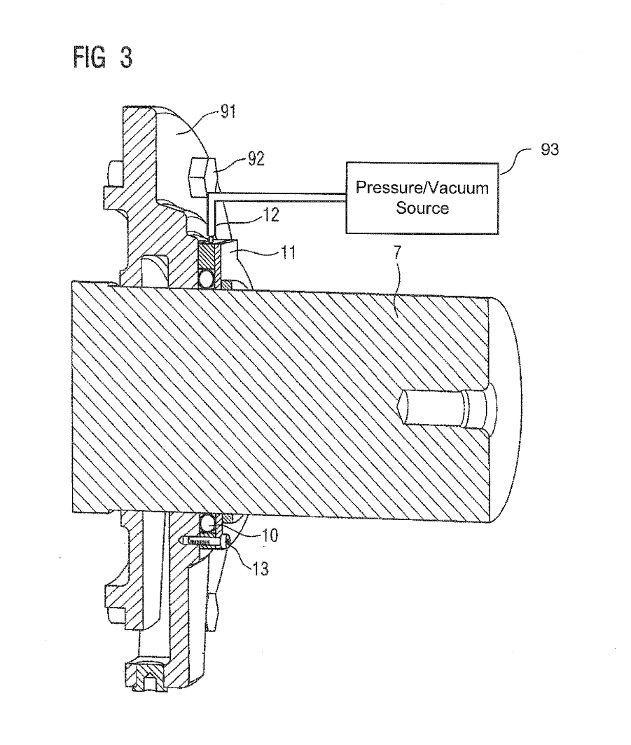

The sealing element 10 can be expanded by an increase in internal pressure. The sealing element 10 is shown in this situation in FIG. 3. An intermediate space extending radially between the circumferential groove and the output shaft 7 is sealed completely by the sealing element 10 when expanded, the sealing element 10 being designed so that it can remain permanently in the gearbox after it has been transported or put into operation. According to a preferred embodiment, the sealing element 10 is coupled to a transportation safety device which controls or regulates the internal pressure.

The sealing element 10 is preferably inserted into the groove as an elastic annular tube. Because of its rigidity, the tube bears against the outside of the groove and has no contact with the output shaft 7 when there is reduced internal pressure. The tube is advantageously made from a material which enlarges its volume, and is deformed only elastically, when the internal pressure is increased relative to the external pressure. The tube is provided with an opening, for example a valve 12. In this way, the internal pressure of the tube can be increased and deceased, respectively, from outside by connecting valve 12 to an external pressure/vacuum source or transport safety device 93. As the internal pressure increases, the volume of the tube is enlarged so much that the tube bears against the output shaft 7 and an inner shell side of the groove. Depending on the internal pressure in the tube and the geometrical design of the groove, the tube can also bear against flanking end surfaces in order to create further sealing surfaces between the tube and the end surfaces. A circumferential groove can, for example, also be provided on an end side of the flange 11, wherein the sealing element 10 can seal an intermediate space which extends axially between a flange section of the output shaft 7 and the groove. By using an elastic material for the tube, small relative movements or vibrations between the output shaft 7 and the gearbox housing 9 can be compensated without this resulting in an undesirably limited sealing function.

A closure part is provided in the region of the circumferential groove for replacing the tube. After the closure part has been removed, the tube can be readily accessed. At least sections of the tube can thus be pulled out of the groove, cut off and then removed. A new tube is preferably installed with a split tube which can be joined materially after installation.

FIGS. 2 and 3 relate, by way of example, to a sealing element 10 for the output shaft 7, but the above embodiments also apply analogously to a sealing element arranged about the input shaft 1.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A gearbox for a wind turbine comprising
a gearbox housing,
an input shaft which can be connected to a rotor hub,
an output shaft which can be connected to a generator,
a first gear wheel connected with a rotation-lock to the input shaft and arranged inside the gearbox housing,
a second gear wheel connected with a rotation-lock to the output shaft and arranged in the gearbox housing, said second gear wheel meshing with the first gear wheel or being coupled to the first gear wheel via one or more additional gear wheels,
at least one flange which radially surrounds at least one of the input shaft and the output shaft and has a circumferential groove on a side facing the input shaft or the output shaft, and
an inflatable annular tubular sealing element made from an elastic material which is secured in the circumferential groove, with the sealing element radially expanding upon inflation and completely sealing an intermediate space between the circumferential groove and at least one of the input shaft or the output shaft.

2. The gearbox of claim 1, wherein under reduced pressure the sealing element surrounds the input shaft or the output shaft without making contact therewith.

3. The gearbox of claim 2, wherein the sealing element is designed so as to permanently remain in the gearbox after the gearbox has been transported and/or placed in service.

4. The gearbox of claim 1, wherein the sealing element is coupled to a transport safety device which controls or regulates an internal pressure inside the sealing element.

5. The gearbox of one claim 1, further comprising a gearbox housing cover for closing the gearbox housing, wherein the at least one flange is part of the housing cover.

6. The gearbox of claim 1, wherein the intermediate space extends radially between the circumferential groove and at least one of the input shaft and the output shaft.

7. The gearbox of claim 6, wherein the circumferential groove is provided on an inner surface of the flange facing at least one of the input shaft and the output shaft.

8. The gearbox of claim 1, wherein the circumferential groove is disposed on a face side of the flange and wherein the input shaft or the output shaft incorporates a flange section, and wherein the intermediate space extends axially between the flange section and the circumferential groove.
